(19) United States
(12) Patent Application Publication
(10) Pub. No.: US 2009/0286917 A1
(43) Pub. Date: Nov. 19, 2009

(54) IMPROVED CATALYST SYSTEM FOR POLYESTER NANOCOMPOSITES

(76) Inventor: Surbhi Mahajan, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/272,845

(22) Filed: Nov. 18, 2008

Related U.S. Application Data
(60) Provisional application No. 61/015,254, filed on Dec. 20, 2007.

(51) Int. Cl. C08K 3/34

(52) U.S. Cl. 524/445

(57) ABSTRACT

Using chelated organic titanate catalysts in the preparation of polyester/sepiolite-type clay nanocomposites by in situ polymerization results in a polymer whose moldings exhibit higher tensile modulus than when open-site organic titanate catalysts are used.

This application claims the benefit of U.S. Provisional Patent Application No. 61/015,254, filed Dec. 20, 2007, which is herein incorporated by reference.

### FIELD OF THE INVENTION

The present Invention relates to methods of forming polyester nanocomposites comprising a sepiolite-type clay nanofiller and a polyester.

### TECHNICAL BACKGROUND OF THE INVENTION

Nanocomposites are polymers reinforced with nanometer sized particles, i.e., particles with a dimension on the order of 1 to several hundred nanometers.

Polymer-layered silicate nanocomposites incorporate a layered clay mineral filler in a polymer matrix. Layered silicates are made up of several hundred thin platelet layers stacked into an orderly packet known as a tactoid. Each of these platelets is characterized by a large aspect ratio (diameter/thickness on the order of 100-1000). Accordingly, when the clay is dispersed homogeneously and exfoliated as individual platelets throughout the polymer matrix, dramatic increases in strength, flexural and Young's modulus, and heat distortion temperature are observed at very low filler loadings (<10% by weight) because of the large surface area contact between polymer and filler. In addition, barrier properties are greatly improved because the large surface area of the platelets greatly increases the tortuosity of the path a diffusing species must follow in permeating through the polymeric material.

U.S. Patent Application Publication 20060205856 discloses a process for manufacturing a thermoplastic polyester nanocomposite composition comprising mixing a sepiolite-type clay with at least one thermoplastic polyester precursor selected from the group consisting of (a) at least one diacid or diester and at least one diol; (b) at least one polymerizable polyester monomer; (c) at least one linear polyester oligomer; (d) at least one macrocyclic polyester oligomer, and subsequently polymerizing said at least one polyester precursor in the presence or absence of a solvent. when the polyester precursor is (a) at least one diacid or diester and at least one diol, the polymerization takes place in two stages, esterification and polycondensation.

In the first stage of the polymerization of the at least one diacid or diester and at least one diol, esterification or ester interchange between the diacid or its dialkyl (typically dimethyl) ester and the diol takes place to give the bis(hydroxyalkyl)ester and some oligomers along with the evolution and removal of water or alcohol (typically methanol). Catalysts are commonly used. Examples of useful esterification or ester-interchange catalysts include without limitation calcium, zinc, and manganese acetates; tin compounds; and titanium alkoxides (also known as organic titanates).

In the second stage, polycondensation, the bis(hydroxyalkyl)ester and oligomers continue to undergo ester-interchange reactions, eliminating diol, which is removed under high vacuum, and building molecular weight.

Examples of useful polycondensation catalysts include without limitation compounds of tin, titanium, antimony, and germanium; particularly antimony oxide (Sb₂O₃) which is commonly used in the case of poly(ethylene terephthalate) (“PET”). When the polyester precursor is already an oligomer, as in (c) and (d) or in some cases (b) (for example, where the process starts with bis(2-hydroxyethyl)terephthalate as a polymerizable monomer), the polymerization consists simply of the polycondensation stage.

It would be desirable to replace the Sb₂O₃ with, for example, a titanate, which is a more environmentally benign polycondensation catalyst. Organic titanates such as tetra-n-butyl titanate (TiTnBT) are already commonly used in the polymerization of poly(butylene terephthalate) (PBT) and poly(1,3-propylene terephthalate) (PPT). However, the mechanical properties, for example, tensile modulus, of moldings of PET nanocomposites made by polymerization in the presence of sepiolite-type clay with TiTnBT as the polycondensation catalyst do not exhibit the same degree of improvement as when the antimony catalysts are used. To improve dispersion, an additional processing step, such as extrusion in a twin-screw extruder, may be needed.

Thus, there remains a need for an improved process preparing polyester nanocomposites by in situ polymerization in the presence of sepiolite-type clay nanoparticles, using an environmental benign and effective catalyst system without the need for additional processing to improve the dispersion of the nanoparticles.

### SUMMARY OF THE INVENTION

A process is provided herein for manufacturing a thermoplastic polyester containing composition comprising mixing a sepiolite-type clay with at least one thermoplastic polyester precursor selected from the group consisting of

a. at least one diacid or diester and at least one diol;

b. at least one polymerizable polyester monomer;

c. at least one linear polyester oligomer;

d. at least one macrocyclic polyester oligomer,

and subsequently polymerizing said at least one polyester precursor in the presence of a chelated organic titanate catalyst.

### BRIEF DESCRIPTION OF THE DRAWINGS

FIG. 1 is a bar plot of the tensile modulus of bars molded using PET compositions made with five different organic titanate catalysts.

FIG. 2 is a is a bar plot of the tensile modulus of bars molded using PET compositions made with either open-site (“open”) or chelated (“closed”) organic titanate catalysts.

### DETAILED DESCRIPTION OF THE INVENTION

In the context of this disclosure, a number of terms shall be utilized.

As used herein, the term “nanocomposite” or “polymer nanocomposite” means a polymeric material which contains particles, dispersed throughout the polymeric material, having at least one dimension in the 0.1 to 100 nm range (“nanoparticles”). The polymeric material in which the nanoparticles are dispersed is often referred to as the “polymer matrix.” The term “polyester composite” refers to a nanocomposite in which the polymeric material includes at least one polyester.

As used herein, the term “sepiolite-type clay” refers to both sepiolite and attapulgite (palygorskite) clays.

As used herein, “polyester” means a condensation polymer in which more than 50 percent of the groups connecting repeat units are ester groups. Thus polyesters may include polyesters, poly(ester-amides) and poly(ester-imides), so long as more than half of the connecting groups are ester groups. Preferably at least 70% of the connecting groups are esters, more preferably at least 90% of the connecting groups are ester, and especially preferably essentially all of the connecting groups are esters. The proportion of ester connecting groups can be estimated to a first approximation by the molar ratios of monomers used to make the polyester.

As used herein, “poly(ethylene terephthalate)” or, equivalently, “PET,” means a polyester in which at least 80, more preferably at least 90, mole percent of the diol repeat units are from ethylene glycol and at least 80, more preferably at least 90, mole percent of the dicarboxylic acid repeat units are from terephthalic acid.

As used herein, “oligomer” means a molecule that contains 2 or more identifiable structural repeat units of the same or different formula.

As used herein, “linear polyester oligomer” means oligomeric material, excluding macrocyclic polyester oligomers, which by itself or in the presence of monomers can polymerize to a higher molecular weight polyester.

As used herein, a “macrocyclic” molecule means a cyclic molecule having at least one ring within its molecular structure that contains 8 or more atoms covalently connected to form the ring.

As used herein, “macrocyclic polyester oligomer” means a macrocyclic oligomer containing 2 or more identifiable ester functional repeat units of the same or different formula.

As used herein, “chelate” or “chelated” denotes a transition metal complex in which the transition metal forms coordinate bonds to a multidentate (i.e., bidentate or higher) ligand. As used herein, “closed-site” is a synonym for “chelated.”

As used herein, “open-site” denotes a transition metal complex that is not chelated.

As used herein, the term “hydrocarbyl”, when used in relation to a radical, denotes a univalent radical containing only carbon and hydrogen.

One aspect of the invention described herein is directed to a process for preparing polyester nanocomposites comprising polymerizing a polyester precursor in the presence of sepiolite-type clay nanoparticles and a chelated organic titanate catalyst.

### Chelated Titanium Catalysts

We have found that using chelated organic titanate catalysts in the preparation of polyester/sepiolite-type clay nanocomposites by in situ polymerization results in a polymer whose moldings exhibit higher tensile modulus that when open-site organic titanate catalysts are used. It is possible that open-site organic titanate catalysts interact more readily with free silanol (Si—OH) groups present on the surface and the ends of the sepiolite-type clay filler. A possible scheme, shown below, involves possible reaction between the Si—OH groups and an open-site catalyst (e.g., TiTnBT, shown in the scheme below) which leads to the formation of Si—O—Ti linkages and splitting out of an alcohol (below, n-butanol, “BuOH”).

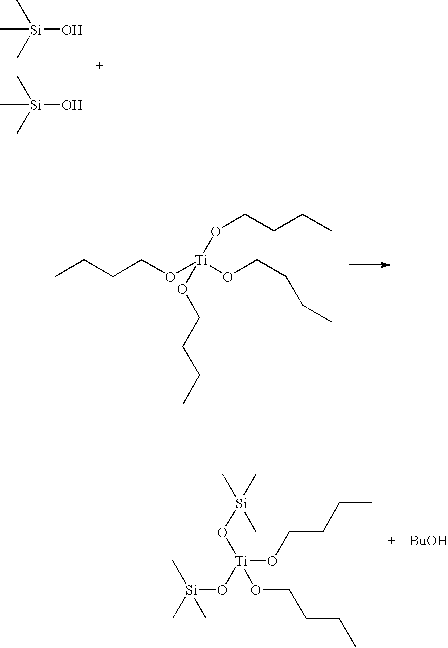

If such reaction occurs between Si—OH groups present on two different sepiolite-type clay nanoparticles, it could hinder the sepiolite dispersion.

In contrast, the steric hindrance and inaccessibility of Ti centers of chelated organic titanate catalysts possibly lessens the interaction of these catalysts with the Si—OH groups, so dispersion of nanoparticles is not hindered. More efficient dispersion of the nanoparticles could then result in a higher tensile modulus than when chelated organic titanate catalysts are used.

The chelated organic titanates are commonly formed from Ti(OR)₄, or titanium tetrahalides, and multidentate (i.e., bi- or higher dentate) ligands. At least one of the functional groups on the ligand is usually an alcoholic or enolic hydroxyl, which can interchange with the group, RO, on the titanium to liberate ROH. Examples of chelating agents for titanium include, without limitation, diols and polyols, α-hydroxycarboxylic acids, oxalic acid, β-keto esters, β-diketones, and alkanolamines. Preparation, compositions, and properties of a wide variety of titanium chelates are reviewed by Donald E. Putzig and Jillian R. Moncarz in “Titanium compounds, Organic,” Kirk-Othmer Encyclopedia of Chemical Technology, John Wiley & Sons, A. Seidel ed., 5^{th} edition, vol. 25, 71-158 (2007) and disclosed in U.S. Pat. No. 6,562,990, both of which are hereby incorporated by reference in their entirety.

In one embodiment, chelated organic titanate catalysts suitable for use in the process described herein are generally described by Formula (I):

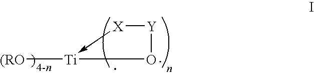

wherein n=1 to 3, each R is independently H or a C₁₋₃₀ hydrocarbyl radical, X is a functional group containing an oxygen or a nitrogen that forms a coordinate bond with the Ti, and Y represents a two- or three-carbon chain. In another aspect of this embodiment, n=2, giving rise to the compound generally described by Formula (II):

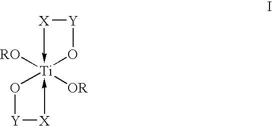

Typically, each R is independently H or a C₁₋₁₂ hydrocarbyl radical.

For example, in the structure below, acetylacetonate titanate chelate [CAS Registry Number 17927-72-9 when R is isopropyl, commercially available as the TYZOR® AA-series from DuPont], X is

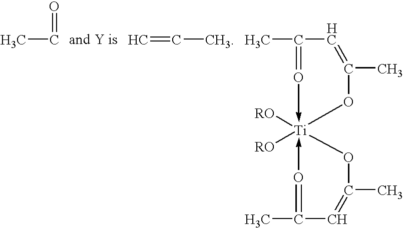

Examples of additional chelated organic titanates suitable for use in the process described herein include without limitation:
Ethyl acetylacetate titanate chelate [CAS Registry Number 27858-32-8 when R is isopropyl, commercially available as TYZOR® DC from DuPont]:

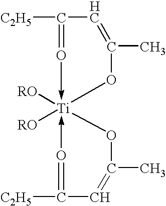

Lactic acid titanate chelate, ammonium salt [CAS Registry Number 65104-065 when R═H, commercially available as TYZOR® LA from DuPont]:

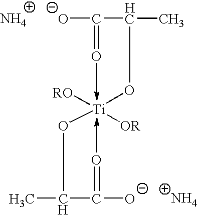

Triethanolamine titanate chelate, a mixture of chelates with at least one component that has the following cage structure [CAS Registry Number is 36673-16-2, commercially available as TYZOR® TE from DuPont]:

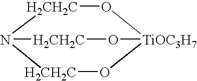

The amount (weight) of catalyst used in the process described herein generally depends upon the titanium content of the particular catalyst. In polycondensation reactions, the amount used is generally expressed as a proportion of the weight of product polyester and is usually from about 5 to about 500 ppm Ti based on product polyester.

### Sepiolite and Attapulgite

The nanocomposite composition contains about 0.1 to about 35 wt % of sepiolite-type clay.

Sepiolite [Mg₄Si₆O₁₅(OH)₂.6(H₂O)] is a hydrated magnesium silicate filler that exhibits a high aspect ratio due to its fibrous structure. Unique among the silicates, sepiolite is composed of long lath-like crystallites in which the silica chains run parallel to the axis of the fiber. The material has been shown to consist of two forms, an α and a β form. The α form is known to be long bundles of fibers and the β form is present as amorphous aggregates.

Attapulgite (also known as palygorskite) is almost structurally and chemically identical to sepiolite except that attapulgite has a slightly smaller unit cell. As used herein, the term “sepiolite-type clay” includes attapulgite as well as sepiolite itself.

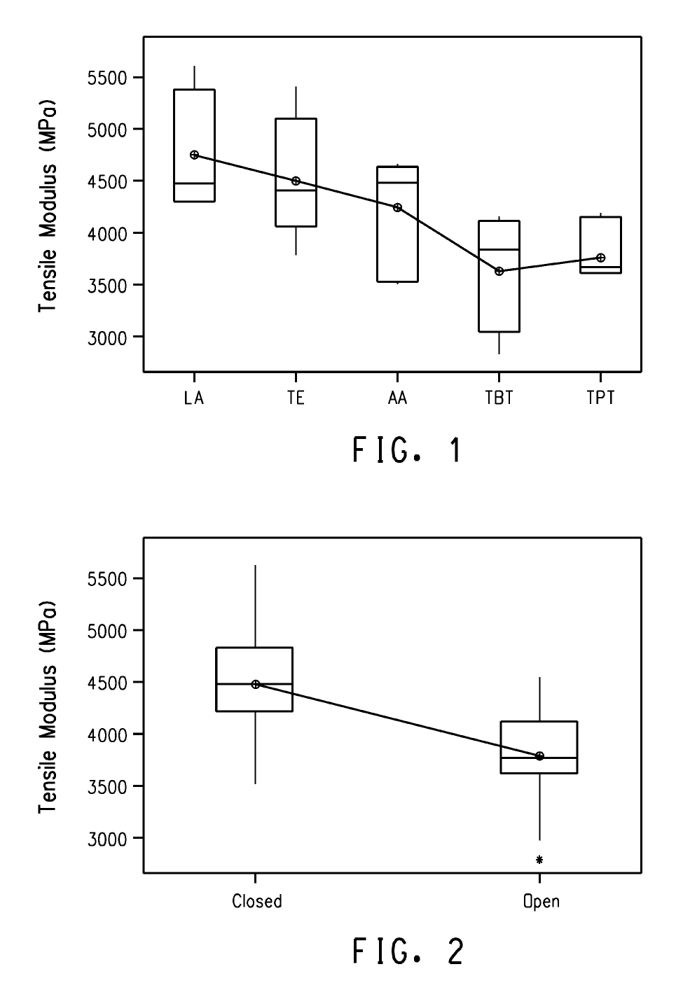

Sepiolite-type clays are layered fibrous materials in which each layer is made up of two sheets of tetrahedral silica units bonded to a central sheet of octahedral units containing magnesium ions (see, e.g., FIGS. 1 and 2 in L. Bokobza et al., Polymer International, 53, 1060-1065 (2004)). The fibers stick together to form fiber bundles, which in turn can form agglomerates. These agglomerates can be broken apart by industrial processes such as micronization or chemical modification (see, e.g., European Patent 170,299 to Tolsa, S. A.) to produce nanometer diameter fibers, i.e., exfoliated sepiolite-type clay.

The amount of sepiolite-type clay used in the present invention ranges from about 0.1 to about 35 wt % based on the final composite composition. The specific amount chosen will depend on the intended use of the nanocomposite, as is well understood in the art.

Sepiolite-type clays are available in a high purity (“Theological grade”), uncoated form (e.g., PANGEL® S9 sepiolite clay from the Tolsa Group, Madrid, Spain) or, more commonly, treated with an organic material to make the clay more “organophilic,” i.e., more compatible with systems of low-to-medium polarity (e.g., PANGEL® B20 sepiolite clay from the Tolsa Group). An example of such a coating for sepiolite-type clay is a quaternary ammonium salt such as dimethylbenzylalkylammonium chloride, as disclosed in European Patent Application 221,225.

The sepiolite-type clay used in the process described herein is typically unmodified; i.e., the surface of the sepiolite-type clay has not been treated with an organic compound (such as an onium compound, for example, to make its surface less polar). Such onium compounds tend to degrade at the temperatures used to process polyesters such as PET.

In an embodiment, the sepiolite-type clay is rheological grade, such as described in European patent applications EP-A-0454222 and EP-A-0170299 and marketed under the trademark Pangel® by Tolsa, S. A., Madrid, Spain. As described therein “rheological grade” denotes a sepiolite-type clay with a specific surface area greater than 120 m²/g (N₂, BET), and typical fiber dimensions: 200 to 2000 nm long, 10-30 nm wide, and 5-10 nm thick.

Rheological grade sepiolite is obtained from natural sepiolite by means of special micronization processes that substantially prevent breakage of the sepiolite fibers, such that the sepiolite disperses easily in water and other polar liquids, and has an external surface with a high degree of irregularity, a high specific surface, greater than 300 m²/g and a high density of active centers for adsorption, that provide it a very high water retaining capacity upon being capable of forming, with relative ease, hydrogen bridges with the active centers. The microfibrous nature of the rheological grade sepiolite nanoparticles makes sepiolite a material with high porosity and low apparent density.

Additionally, rheological grade sepiolite has a very low cationic exchange capacity (10-20 meq/100 g) and the interaction with electrolytes is very weak, which in turn causes rheological grade sepiolite not to be practically affected by the presence of salts in the medium in which it is found, and therefore, it remains stable in a broad pH range.

The above-mentioned qualities of rheological grade sepiolite can also be attributed to rheological grade attapulgite with particle sizes smaller than 40 microns, such as for example the range of ATTAGEL goods (for example ATTAGEL 40 and ATTAGEL 50) manufactured and marketed by the firm Engelhard Corporation, United States, and the MIN-U-GEL range of Floridin Company.

Typically, the amount of sepiolite-type clay used in the present invention ranges from about 0.1 to about 35 wt % based on the total amount of sepiolite-type clay and polyester in the nanocomposite composition. The specific amount chosen will depend on the intended use of the nanocomposite composition, as is well understood in the art. For example, in film, it may be advantageous to use as little sepiolite-type clay as possible, so as to retain desired optical properties.

### Polyesters

Polyesters (which have mostly or all ester linking groups) are normally derived from one or more dicarboxylic acids and one or more diols. They can also be produced from polymerizable polyester monomers or from macrocyclic or linear polyester oligomers as described in copending U.S. patent application Ser. Nos. 11/312,068 and 11/767,035, herein incorporated by reference in their entirety.

The production of polyesters from reaction mixtures containing diols and hydrocarbyl diacids or esters of such diacids is well known in the art, as described by A. J. East, M. Golden, and S. Makhija in the Kirk-Othmer Encyclopedia of Chemical Technology, John Wiley & Sons, J. I. Kroschwitz exec. ed., M. Howe-Grant, ed., 4^{th} edition (1996), vol. 19, 609-653. Among suitable diacids (and their corresponding esters) are those selected from the group consisting of terephthalic acid, isophthalic acid, naphthalene dicarboxylic acids, cyclohexane dicarboxylic acids, succinic acid, glutaric acid, adipic acid, sebacic acid, 1,12-dodecane dioic acid fumaric acid, maleic acid, and the derivatives thereof, such as, for example, the dimethyl, diethyl, or dipropyl esters.

Some representative examples of glycols that can be utilized as the diol component include ethylene glycol, 1,3-propylene glycol, 1,2-propylene glycol, 2,2-diethyl-1,3-propane diol, 2,2-dimethyl-1,3-propane diol, 2-ethyl-2-butyl-1,3-propane diol, 2-ethyl-2-isobutyl-1,3-propane diol, 1,3-butane diol, 1,4-butane diol, 1,5-pentane diol, 1,6-hexane diol, 2,2,4-trimethyl-1,6-hexane diol, 1,2-cyclohexane dimethanol, 1,3-cyclohexane dimethanol, 1,4-cyclohexane dimethanol, 2,2,4,4-tetramethyl-1,3-cyclobutane diol, isosorbide, naphthalene glycols, biphenols, diethylene glycol, triethylene glycol, resorcinol, hydroquinone, t-butyl-hydroquinone, and longer chain diols and polyols, such as polytetramethylene ether glycol, which are the reaction products of diols or polyols with alkylene oxides. Alkyl-substituted and chloro-substituted versions of these species may also be used.

Polyesters suitable for use in the present invention can also be produced directly from reaction mixtures containing polymerizable polyester monomers. Some representative examples of said polymerizable polyester monomers hydroxyacids such as hydroxybenzoic acids, hydroxynaphthoic acids and lactic acid; bis(2-hydroxyethyl)terephthalate, bis(4-hydroxybutyl)terephthalate, bis(2-hydroxyethyl)naphthalenedioate, bis(2-hydroxyethyl)isophthalate, bis[2-(2-hydroxyethoxy)ethyl]terephthalate, bis[2-(2-hydroxyethoxy)ethyl]isophthalate, bis[(4-hydroxymethylcyclohexyl)methyl]terephthalate, and bis[(4-hydroxymethylcyclohexyl)methyl]isophthalate, mono(2-hydroxyethyl)terephthalate, bis(2-hydroxyethyl)sulfoisophthalate, and lactide. Alkyl-substituted and chloro-substituted versions of these species may also be used.

Linear polyester oligomers include, for example, oligomers of linear polyesters and oligomers of polymerizable polyester monomers. For example, reaction of dimethyl terephthalate or terephthalic acid with ethylene glycol, when carried out to remove methyl ester or carboxylic groups, usually yields a mixture of bis(2-hydroxyethyl)terephthalate and a variety of oligomers: oligomers of bis(2-hydroxyethyl)terephthalate, oligomers of mono(2-hydroxyethyl)terephthalate (which contain carboxyl groups), and polyester oligomers capable of being further extended. Typically, such oligomers will have an average degree of polymerization (average number of monomer units) of about 20 or less, more typically about 10 or less. The linear polyester oligomers may be obtained as a byproduct of a polyester polymer manufacturing process; by degrading (“cracking”) polyester polymer, for example, by alcoholysis; or by glycolysis.

Polyester polymers can also be produced directly from reaction mixtures containing macrocyclic polyester oligomers. Examples of suitable macrocyclic polyester oligomers include without limitation macrocyclic polyester oligomers of 1,4-butylene terephthalate (CBT); 1,3-propylene terephthalate (CPT); 1,4-cyclohexylenedimethylene terephthalate (CCT); ethylene terephthalate (CET); 1,2-ethylene 2,6-naphthalenedicarboxylate (CEN); the cyclic ester dimer of terephthalic acid and diethylene glycol (CPEOT); and macrocyclic co-oligoesters comprising two or more of the above structural repeat units. Alkyl-substituted and chloro-substituted versions of these species may also be used.

The polyesters may be branched or unbranched, and may be homopolymers or copolymers or polymeric blends comprising at least one such homopolymer or copolymer.

Examples of specific polyesters include without limitation poly(ethylene terephthalate) (PET), poly(1,3-propylene terephthalate) (PPT), poly(1,4-butylene terephthalate) (PBT), a thermoplastic elastomeric polyester having poly(1,4-butylene terephthalate) and poly(tetramethylene ether)glycol blocks (available as HYTREL® from E. I. du Pont de Nemours & Co., Inc., Wilmington, Del. 19898 USA), poly(1,4-cylohexyldimethylene terephthalate) (PCT), and polylactic acid (PLA).

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of the present invention, suitable methods and materials are described herein.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Use of “a” or “an” are employed to describe elements and components of the invention. This is done merely for convenience and to give a general sense of the invention. This description should be read to include one or at least one and the singular also includes the plural unless it is obvious that it is meant otherwise.

The materials, methods, and examples herein are illustrative only and, except as specifically stated, are not intended to be limiting.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Materials

Bis(2-hydroxyethyl terephthalate); TYZOR® AA-105, acetylacetonate titanate chelate; TYZOR® TE, triethanolamine titanate chelate; TYZOR® LA, lactic acid titanate chelate, ammonium salt; TYZOR® TnBT, tetra-n-butyl titanate; and TYZOR® TPT, tetraisopropyl titanate were obtained from E. I. du Pont de Nemours & Co., Inc. (Wilmington, Del., USA).

Pangel® S-9 sepiolite was purchased from EM Sullivan Associates, Inc. (Paoli, Pa., USA), a distributor for the manufacturer, Tolsa S. A. (Madrid 28001, Spain). Pangel® S-9 is a rheological grade of sepiolite that has an unmodified surface.

The meaning of abbreviations is as follows: “MPa” means megapascal(s), “ppm” means parts per million, “sd” means standard deviation, and “wt %” means weight percent(age).

### Example 1

The starting monomer bis(2-hydroxyethyl) terephthalate was added to a reactor along with 3 wt % Pangel® S-9 sepiolite) and an organic titanate catalyst as indicated in Table 1, at a level of 25 ppm Ti: The system was purged with a controlled rate of N₂ flow and then taken through a series of temperature ramps between 180° C. and 290° C. (maintained by a metal bath), to undergo transesterification and glycolysis to generate short-chain oligomers and the by-product ethylene glycol which was collected by a series of three traps before the vacuum manifold. The final controlled vacuum ramp at 290° C. generated high viscosity in the melt which was measured by the torque read out, and increased as the polymer built up its molecular weight. The polymerization was stopped when an appreciable amount of torque was reached, generally after about 0.5 to about 3.5 hours, corresponding to a polymer molecular weight high enough for injection molding test samples. Polymer was molded into ASTM D638 mini-tensile bars for determining tensile modulus.

Results are presented in Table 1 and FIGS. 1 and 2. The tensile modulus numbers in Table 1 are each the average of results five or six bars, except seven bars were used for the composition containing TYZOR® TPT. FIG. 1 is a comparison of individual compositions made with different catalysts and FIG. 2 is a comparison of the group of compositions made with chelated (“closed”) catalysts with the group of compositions made with open site catalysts. One-Way Anova analysis of the five compositions individually showed that the tensile modulus of at least one of the samples was statistically significantly different (p=0.005). A Two-Sample t-test comparing the group of compositions made with chelated (“closed”) catalysts with the group of group of compositions made with open site catalysts showed that the modulus results of the two groups were statistically significantly different (p=0.000), the compositions made with chelated (“closed”) catalysts having higher tensile modulus.

TABLE 1

| | Chelated* or | Tensile Modulus, |
|---|---|---|
| Catalyst | Open-Site? | MPa (sd) |
| TYZOR ® AA-105, acetylacetonate | Chelated | 4229 (551) |
| titanate chelate | | |
| TYZOR ® TE, triethanolamine | Chelated | 4524 (597) |
| titanate chelate | | |
| TYZOR ® LA, lactic acid titanate | Chelated | 4778 (595) |
| chelate, ammonium salt | | |
| TYZOR ® TnBT, tetra-n-butyl | Open-site | 3641 (550) |
| titanate | | |
| TYZOR ® TPT, tetraisopropyl | Open-site | 3814 (258) |
| titanate | | |

What is claimed is:

1. A process manufacturing a thermoplastic polyester containing composition comprising mixing a sepiolite-type clay with at least one thermoplastic polyester precursor selected from the group consisting of
a. at least one diacid or diester and at least one diol;
b. at least one polymerizable polyester monomer;
c. at least one linear polyester oligomer;
d. at least one macrocyclic polyester oligomer,
and subsequently polymerizing said at least one polyester precursor in the presence of a chelated organic titantate catalyst.

2. The process of claim 1 wherein the polyester is poly(ethylene terephthalate).

3. The process of claim 1 wherein the sepiolite-type clay is rheological grade.

4. The process of claim 1 wherein the chelated organic titanate is generally described by Formula (II) 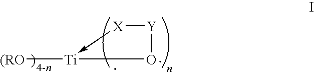
wherein n=1 to 3, each R is independently H or a C₁₋₃₀ hydrocarbyl radical, X is a functional group containing an oxygen or a nitrogen that forms a coordinate bond with the Ti, and Y represents a two- or three-carbon chain.

5. The process of claim 3 wherein n=2.

6. The process of claim 1 wherein the chelated titanate catalyst comprises at least one compound selected from the group consisting of [chemical structure]
